(19) United States
(12) Patent Application Publication
(10) Pub. No.: US 2004/0234092 A1
(43) Pub. Date: Nov. 25, 2004

(54) Hearing aid system and hearing aid method

(76) Inventors: Hiroshi Wada, Sendai-Shi (JP); Takuji Koike, Chofu-Shi (JP); Toshimitsu Kobayashi, Sendai-Shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/863,295

(22) Filed: Jun. 9, 2004

Related U.S. Application Data
(63) Continuation of application No. PCT/JP03/02361, filed on Feb. 28, 2003.

(30) Foreign Application Priority Data
Jul. 24, 2002 (JP) 2002-215762

(51) Int. Cl. H04R 25/00; H04R 9/06

(52) U.S. Cl. 381/331; 381/328; 381/401

(57) ABSTRACT

Sound input to a microphone is converted into an electrical signal and the electrical signal is amplified by an amplifier. The amplified electrical signal is supplied to a primary coil as an alternating current. Thus, a magnetic field around the primary coil varies with time and a secondary coil generates an induced electromotive force. A vibrating coil is supplied with current generated by the induced electromotive force and thus an induced magnetic field is generated around the vibrating coil. The vibrating coil provided on the surface of an eardrum is vibrated by interaction between the induced magnetic field and a magnetostatic field generated by a permanent magnet.

### CROSS-REFERENCE TO RELATED APPLICATIONS

This is a Continuation Application of PCT Application No. PCT/JP03/02361, filed Feb. 28, 2003, which was not published under PCT Article 21(2) in English.

This application is based upon and claims the benefit of priority from prior Japanese Patent Application No. 2002-215762, filed Jul. 24, 2002, the entire contents of which are incorporated herein by reference.

### BACKGROUND OF THE INVENTION

1. Field of the Invention

The present invention relates to a hearing aid system and a hearing aid method that uses an electromagnetic coil to vibrate a vibrating coil rested on the surface of an eardrum.

2. Description of the Related Art

A hearing aid is an apparatus that collects and amplifies a sound such that the hearing impaired can easily catch the sound. Currently used hearing aids can largely be divided into two types. One is an earphone type hearing aid that is generally popularized. This type of hearing aid is located in an external ear region to amplify and output an external sound and vibrate an eardrum by aerial vibration. The earphone type hearing aid is of, for example, a portable earphone radio type, a behind-the-ear type, and an external-auditory-meatus insertion type such as an earplug.

The other is an artificial middle ear type hearing aid in which a vibrator such as a piezoelectric device and a permanent magnet is directly attached to auditory ossicle and vibrated. This type of hearing aid is not influenced by acoustic characteristics of an external auditory meatus and thus can provide a high-quality sound.

However, the hearing aides of the above types have the following problems.

The earphone type hearing aid is placed on an external auditory meatus that is narrowed and shaped complicatedly. It is thus difficult to achieve characteristics of correctly amplifying sound pressure to a high audio frequency. If a passage through which sound is transmitted is a complicated, tube-shaped one such as an external auditory meatus, resonance and interference occur. Sound transmitted through the hearing aid therefore differs from a natural sound.

The artificial middle ear type hearing aid necessitates an “invasion” of a human body to attach a vibrator. Specifically, part of a skull should be shaved and an auditory ossicle of a middle ear should be removed. An emotional and physical load on a user therefore increases.

### BRIEF SUMMARY OF THE INVENTION

The present invention has been developed in consideration of the above situation and its object is to provide a hearing aid system and a hearing aid method capable of achieving characteristics of correctly amplifying sound pressure even in a high audio frequency without any invasion of a human body.

A hearing aid system according to a first aspect of the present invention, which is provided from an external ear region to an eardrum, comprises a current generator which generates current based on an input external sound, a first coil which induces variations in magnetic field with time based on the current, a second coil which generates an induced electromotive force based on the variation in magnetic field with time, a magnetic field generator which faces the eardrum, and a vibrating coil electrically connected to the second coil and provided on the eardrum, which generates a magnetic field whose polarity varies with the electromotive force and vibrates by interaction between the magnetic field whose polarity varies and a magnetic field generated by the magnetic field generator.

As a second aspect of the present invention, in the hearing aid system according to the first aspect, the vibrating coil is adhered to a surface of the eardrum facing the external ear region using one of oil and a clip.

As a third aspect of the present invention, in the hearing aid system according to the first aspect, a portion that contacts a human body is coated with biocompatible insulating materials.

As a fourth aspect of the present invention, in the hearing aid system according to the first aspect, the magnetic field generator is located in the external ear region close to a middle ear region.

As a fifth aspect of the present invention, in the hearing aid system according to the first aspect, the vibrating coil weighs 20 mg or less.

As a sixth aspect of the present invention, in the hearing aid system according to the first aspect, the vibrating coil is shaped like a disk.

As a seventh aspect of the present invention, in the hearing aid system according to the first aspect, a distance between the magnetic field generator and the vibrating coil is controlled to adjust intensity of the induced magnetic field.

As an eighth aspect of the present invention, in the hearing aid system according to the first aspect, the magnetic field generator is a permanent magnet.

A hearing aid method according to a ninth aspect of the present invention, comprises generating an alternating current based on an external sound input from sound input means provided in an external ear region, causing the alternating current to flow through a first coil to induce variations in magnetic field with time, generating an induced electromotive force from a second coil based on the variations in magnetic field with time, causing a vibrating coil provided on an eardrum to generate an induced magnetic field whose polarity varies based on the induced electromotive force, and vibrating the vibrating coil by a magnetostatic field generated by a magnet that faces the eardrum and the induced magnetic field generated by the vibrating coil, thereby vibrating the eardrum.

As a tenth aspect of the present invention, in the hearing aid method according to the ninth aspect, the vibrating coil is adhered to a surface of the eardrum facing the external ear region using one of oil and a clip.

As an eleventh aspect of the present invention, in the hearing aid method according to the ninth aspect, a portion that contacts a human body is coated with biocompatible insulating materials.

As a twelfth aspect of the present invention, in the hearing aid method according to the ninth aspect, the magnet is located in the external ear region close to a middle ear region.

As a thirteenth aspect of the present invention, in the hearing aid method according to the ninth aspect, the vibrating coil weighs 20 mg or less.

As a fourteenth aspect of the present invention, in the hearing aid method according to the ninth aspect, the vibrating coil is shaped like a disk.

As a fifteenth aspect of the present invention, in the hearing aid method according to the ninth aspect, a distance between the magnet and the vibrating coil is controlled to adjust intensity of the induced magnetic field.

### BRIEF DESCRIPTION OF THE SEVERAL VIEWS OF THE DRAWING

FIG. 1 is a schematic diagram illustrating a configuration of a hearing aid system according to an embodiment of the present invention.

FIG. 2 is a schematic diagram illustrating a configuration of the hearing aid system according to the embodiment of the present invention.

FIG. 3 is a graph showing a relationship between audio frequency and sound pressure in a cochlea when vibrating coils 21 that differ in mass are rested on the surface of an eardrum and an exciting force corresponding to a sound pressure of 80 dBSPL is applied thereto.

### DETAILED DESCRIPTION OF THE INVENTION

An embodiment of the present invention will now be described with reference to the drawings. In the following descriptions, the components having substantially the same function and configuration are denoted by the same reference numerals and their descriptions are repeated only when the need arises.

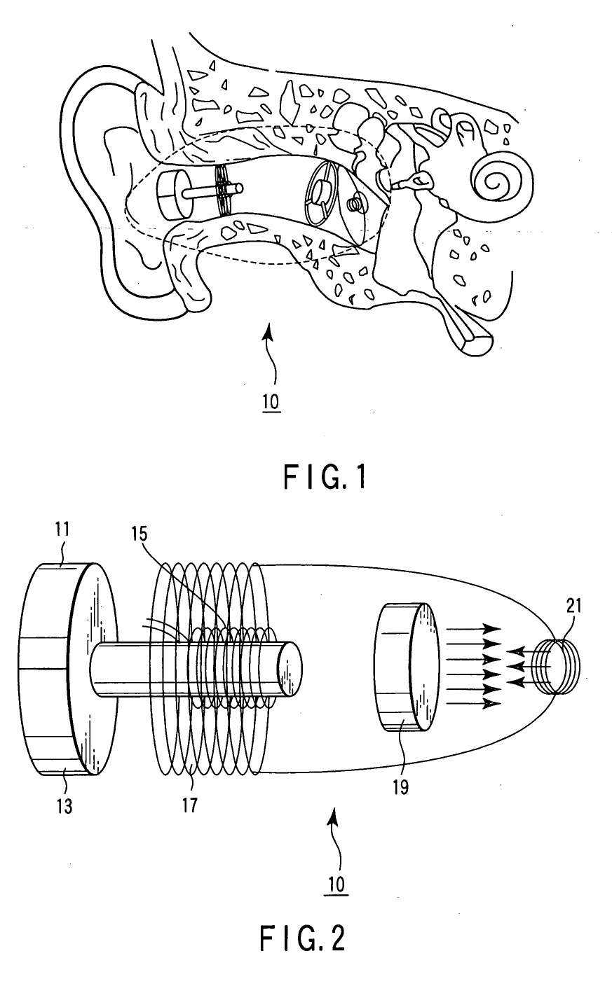

FIGS. 1 and 2 are schematic diagrams each showing a configuration of a hearing aid system according to an embodiment of the present invention. As shown in FIGS. 1 and 2, the present hearing aid system includes a microphone 11, an amplifier 13, a primary coil 15, a secondary coil 17, a permanent magnet 19 and a vibrating coil 21.

The microphone 11 receives an external sound such as a conversational sound and converts it into an electrical signal.

The amplifier 13 amplifies the electrical signal, into which the sound is converted by the microphone 11, to a given intensity level. The intensity of the amplification can be controlled to have an arbitrary level.

The electrical signal amplified by the amplifier 13 flows through the primary coil 15. The primary coil 15 therefore generates an induced magnetic field as the electrical signal varies with sound.

The secondary coil 17 generates an induced electromotive force as the magnetic field generated by the primary coil 15 varies. In the present embodiment, though the secondary coil 17 is not limited to a specific shape, it is shaped to surround the primary coil 15 in order to increase the density of magnetic flux going through the secondary coil 17 and generate an induced electromotive force with efficiency.

The permanent magnet 19 is supported by a given frame and fixed on an external auditory meatus. As will be described later, a magnetostatic field generated by the permanent magnet 19 serves as a driving source for vibrating the vibrating coil 21. In order to bring efficiency to the vibration and prevent a shift in position due to the contact of the permanent magnet 19 with a user's finger or the like, the permanent magnet 19 favorably faces the vibrating coil 21 as close as possible to an eardrum (or in an external auditory meatus as close as possible to a middle ear).

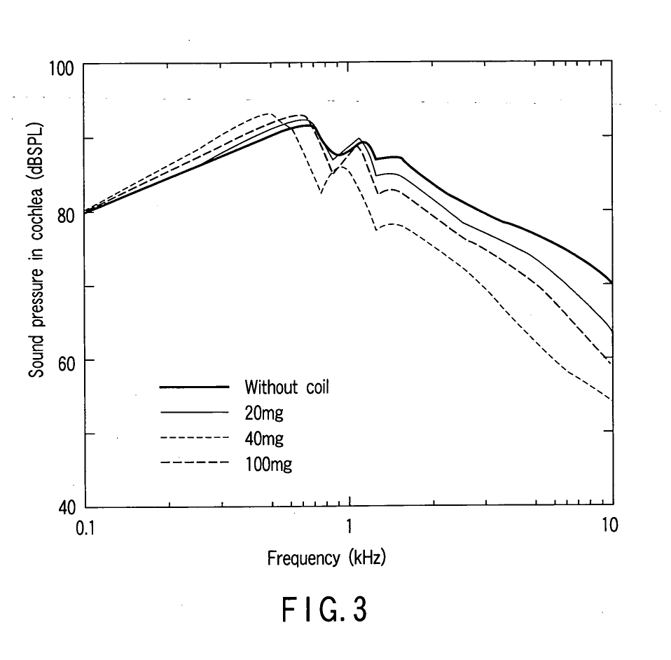

The vibrating coil 21 is a lightweight coil that is adhered to the surface of an eardrum facing an external auditory meatus using oil. According to inventors' experiment, if the coil weighs, e.g., 20 mg or less, it can considerably decrease in its inertia and generate a nearly natural sound (see FIG. 3). The vibrating coil 21 can be provided with a clip made of shape memory alloy which holds a region spanning the surface of an eardrum facing an external auditory meatus and part of an auditory ossicle.

The vibrating coil 21 is not limited to a specific shape. It is however desirable that the vibrating coil 21 be shaped like a disk in order to increase the internal magnetic field of the vibrating coil 21 such that the coil 21 can generate a greater exciting force, vibrate minutely at high speed and ensure dynamic stability.

It is desirable that a portion of each of the above-described components, which is likely to contact user's skin, be coated with biocompatibility materials in order to prevent the skin from being irritated. It is also desirable that a portion of each of the components through which current flows be coated with leakage current preventing materials in order to prevent current from leaking to tissues from a living body. For example, silicon is material that meets the above two conditions.

There now follows an explanation of the operating principle of the present hearing aid system.

In FIG. 2, when the microphone 11 receives an external sound, the sound is converted into an electrical signal. The amplifier 13 amplifies the electrical signal to a given intensity level.

The amplified electrical signal is supplied to the primary coil 15 as an alternating current. When the alternating current flows through the primary coil 15, a magnetic field around the primary coil 15 varies with time to change a magnetic flux that goes through the secondary coil 17. Consequently, the secondary coil 17 generates an induced electromotive force that is proportionate to the variations of the magnetic field with time.

The vibrating coil 21 electrically connected to the secondary coil 17 is supplied with current caused by the induced electromotive force generated from the secondary coil 17. When the current caused by the induced electromotive force flows through the vibrating coil 21, an induced magnetic field due to the induced electromotive force is generated around the vibrating coil 21. The vibrating coil 21 generates a driving force that excites an eardrum by interaction between the induced magnetic field and the magnetostatic field formed by the permanent magnet 19.

More specifically, sound input to the microphone 11 is transmitted to the vibrating coil 21, which is provided on the surface of an eardrum as an exciting force, through the alternating current supplied to the primary coil 15, the induced electromotive force generated from the secondary coil 17, and the interaction between the induced magnetic field caused by the induced electromotive force and the magnetostatic field of the permanent magnet 19. The external sound can thus be transmitted to the eardrum as vibration, which functions as a hearing aid.

The above configuration can produce the following advantage.

The present hearing aid system 10 employs the lightweight vibrating coil 21. Since, therefore, the inertia of the vibrating coil 21 is small, the vibration can efficiently be transmitted to the surface of an eardrum even though an external sound in a high audio frequency band is input.

FIG. 3 is a graph showing a relationship between audio frequency and sound pressure in a cochlea when vibrating coils 21 that differ in mass (20 mg, 40 mg, 100 mg) are rested on the surface of an eardrum and an exciting force corresponding to a sound pressure of 80 dBSPL is applied thereto. Referring to FIG. 3, almost the same sound pressure as in the normal state with no vibrating coils 21 (thick solid line in the figure) can be obtained if the vibrating coils 21 are reduced in weight.

The present hearing aid system 10 is so configured that the lightweight vibrating coils 21 are adhered by oil or the like and the microphone 11, permanent magnet 19, etc. are placed from an external ear region and an eardrum. Hence, these components can easily be attached without performing any operation for invasion of a human body. As a result, growing infants to aged persons can use the hearing aid system at ease.

A conventional earphone type hearing aid amplifies sound input to a microphone and transmits the amplified sound directly to an eardrum. In this configuration to vibrate the eardrum directly by sound waves, resonance and interference of the sound waves are likely to occur in an external auditory meatus that is narrowed and shaped complicatedly. Consequently, there is a case where a natural sound is not faithfully reproduced from the sound transmitted through the hearing aid. In the conventional earphone type hearing aid, the earphone and microphone are close to each other and thus the microphone is likely to receive sound again from the earphone to cause a howl.

In the present hearing aid system 10, an eardrum is vibrated by vibrating the vibrating coil 21 provided on the surface of the eardrum by magnetic interaction using electromagnetic induction. Therefore, the hearing aid system 10 neither causes a phenomenon such as resonance and interference of sound waves and a howl nor subjects to acoustical constraints, unlike the conventional hearing aid. A natural sound of high quality can thus be reproduced faithfully.

The present hearing aid system 10 also amplifies an electrical signal into which an input sound is converted, generates magnetic interaction using electromagnetic induction in response to the amplified electrical signal, and vibrates the vibrating coil 21 provided on the surface of an eardrum. By controlling the degree of amplification of the electrical signal, the distance between the vibrating coil 21 and permanent magnet 19 and the like, a greater magnetic interaction can be generated and so can be a driving force for vibrating the vibrating coil 21. Since the hearing aid system has such characteristics and does not subject to the above acoustical constraints, it can provide highly mixed hearing-impaired persons with a clear sound.

The present hearing aid system 10 is a simple, low-cost apparatus and thus can provide many people with good communication in an aging society that is expected in the near future.

The present invention has been described based on the embodiment thereof. Persons with ordinary skill in the art can think of various changes and modifications within the category of the concept of the present invention. It is understood that the changes and modifications fall within the scope of the present invention. Various changes and modifications can be made without departing from the scope of the subject matter of the present invention.

Embodiments can be combined appropriately as much as possible and, in this case, an advantage can be obtained from the combination. The above embodiments contain inventions in various stages and these inventions can be extracted from appropriate combinations of a plurality of components disclosed in the embodiments. Even though some of all the components shown in the embodiments are deleted, the structure of the remaining components can be extracted as an invention if the problem of the invention can be resolved and the advantage of the invention is obtained.

The present invention can provide a hearing aid system and a hearing aid method capable of achieving characteristics of correctly amplifying sound pressure even in a high audio frequency without any invasion of a human body.

What is claimed is:

1. A hearing aid system provided from an external ear region to an eardrum, comprising:
a current generator which generates current based on an input external sound;
a first coil which induces variations in magnetic field with time based on the current;
a second coil which generates an induced electromotive force based on the variation in magnetic field with time;
a magnetic field generator which faces the eardrum; and
a vibrating coil electrically connected to the second coil and provided on the eardrum, which generates a magnetic field whose polarity varies with the electromotive force and vibrates by interaction between the magnetic field whose polarity varies and a magnetic field generated by the magnetic field generator.

2. The hearing aid system according to claim 1, wherein the vibrating coil is adhered to a surface of the eardrum facing the external ear region using one of oil and a clip.

3. The hearing aid system according to claim 1, wherein a portion that contacts a human body is coated with biocompatible insulating materials.

4. The hearing aid system according to claim 1, wherein the magnetic field generator is located in the external ear region close to a middle ear region.

5. The hearing aid system according to claim 1, wherein the vibrating coil weighs 20 mg or less.

6. The hearing aid system according to claim 1, wherein the vibrating coil is shaped like a disk.

7. The hearing aid system according to claim 1, wherein a distance between the magnetic field generator and the vibrating coil is controlled to adjust intensity of the induced magnetic field.

8. The hearing aid system according to claim 1, wherein the magnetic field generator is a permanent magnet.

9. A hearing aid method comprising:
generating an alternating current based on an external sound input from sound input means provided in an external ear region;
causing the alternating current to flow through a first coil to induce variations in magnetic field with time;
generating an induced electromotive force from a second coil based on the variations in magnetic field with time;
causing a vibrating coil provided on an eardrum to generate an induced magnetic field whose polarity varies based on the induced electromotive force; and
vibrating the vibrating coil by a magnetostatic field generated by a magnet that faces the eardrum and the induced magnetic field generated by the vibrating coil, thereby vibrating the eardrum.

10. The hearing aid method according to claim 9, wherein the vibrating coil is adhered to a surface of the eardrum facing the external ear region using one of oil and a clip.

11. The hearing aid method according to claim 9, wherein a portion that contacts a human body is coated with biocompatible insulating materials.

12. The hearing aid method according to claim 9, wherein the magnet is located in the external ear region close to a middle ear region.

13. The hearing aid method according to claim 9, wherein the vibrating coil weighs 20 mg or less.

14. The hearing aid method according to claim 9, wherein the vibrating coil is shaped like a disk.

15. The hearing aid method according to claim 9, wherein a distance between the magnet and the vibrating coil is controlled to adjust intensity of the induced magnetic field.
